(19) United States
(12) Patent Application Publication
(10) Pub. No.: US 2016/0011527 A1
(43) Pub. Date: Jan. 14, 2016

(54) ELECTROPHOTOGRAPHIC PHOTOSENSITIVE MEMBER, METHOD FOR PRODUCING ELECTROPHOTOGRAPHIC PHOTOSENSITIVE MEMBER, PROCESS CARTRIDGE, AND ELECTROPHOTOGRAPHIC APPARATUS

(71) Applicant: CANON KABUSHIKI KAISHA, Tokyo (JP)

(72) Inventors: Takeshi Murakami, Numazu-shi (JP); Kazumichi Sugiyama, Numazu-shi (JP); Daisuke Kawaguchi, Susono-shi (JP); Daisuke Tanaka, Yokohama-shi (JP)

(21) Appl. No.: 14/793,497

(22) Filed: Jul. 7, 2015

(30) Foreign Application Priority Data
Jul. 9, 2014 (JP) 2014-141767
May 28, 2015 (JP) 2015-109183

(51) Int. Cl. G03G 15/00

(52) U.S. Cl. CPC G03G 5/02

(57) ABSTRACT

An electrophotographic photosensitive member includes a support and an undercoat layer on the support. The undercoat layer contains a metal oxide particle. The metal oxide particle contains a compound represented by any one of the formulae (A-1) to (A-10) and a compound represented by any one of the formulae (B-1) and (B-2) on the surface thereof.

### BACKGROUND OF THE INVENTION

1. Field of the Invention

The present invention relates to an electrophotographic photosensitive member, a method for producing an electrophotographic photosensitive member, a process cartridge including the electrophotographic photosensitive member, and an electrophotographic apparatus including the electrophotographic photosensitive member.

2. Description of the Related Art

Electrophotographic photosensitive members to be installed in electrophotographic apparatuses include an undercoat layer containing a metal oxide particle between a support and a photosensitive layer. It is known that the surface of the metal oxide particle is modified with an organic compound in order to suppress charge injection from the support to the photosensitive layer and to suppress accumulation of electric charge in the photosensitive layer.

For example, Japanese Patent Laid-Open No. 10-301314 and Japanese Patent Laid-Open No. 04-229872 describe a technique for treating (surface-treating) the surface of metal oxide particle with an alkylalkoxysilane. Japanese Patent Laid-Open No. 2010-127963 and Japanese Patent Laid-Open No. 2006-30698 describe a technique for modifying the surface of a metal oxide particle with an electron-transport material and thereby suppressing accumulation of electric charge in a photosensitive layer.

On the basis of study results, the present inventors found the following problem in photosensitive members that contain a metal oxide particle whose surface has been treated with an alkylalkoxysilane and with an electron-transport material in order to suppress charge injection from a support to a photosensitive layer and to suppress accumulation of electric charge in the photosensitive layer. That is, because accumulation of electric charge in an undercoat layer is not sufficiently suppressed, the electric potential is likely to vary during a repeated image forming period.

### SUMMARY OF THE INVENTION

Aspects of the present invention provide an electrophotographic photosensitive member that includes an undercoat layer containing a metal oxide particle whose surface has been modified with both an alkylalkoxysilane and an electron-transport material. The electrophotographic photosensitive member has reduced variations in electric potential during a repeated image forming period. Aspects of the present invention also provide a method for producing the electrophotographic photosensitive member. Aspects of the present invention also provide a process cartridge and an electrophotographic apparatus each including the electrophotographic photosensitive member.

Aspects of the present invention provide an electrophotographic photosensitive member including

a support, and
an undercoat layer on the support.

The undercoat layer includes a metal oxide particle whose surface contains

a compound represented by any one of the following formulae (A-1) to (A-10), and
a compound represented by any one of the following formulae (B-1) and (B-2),

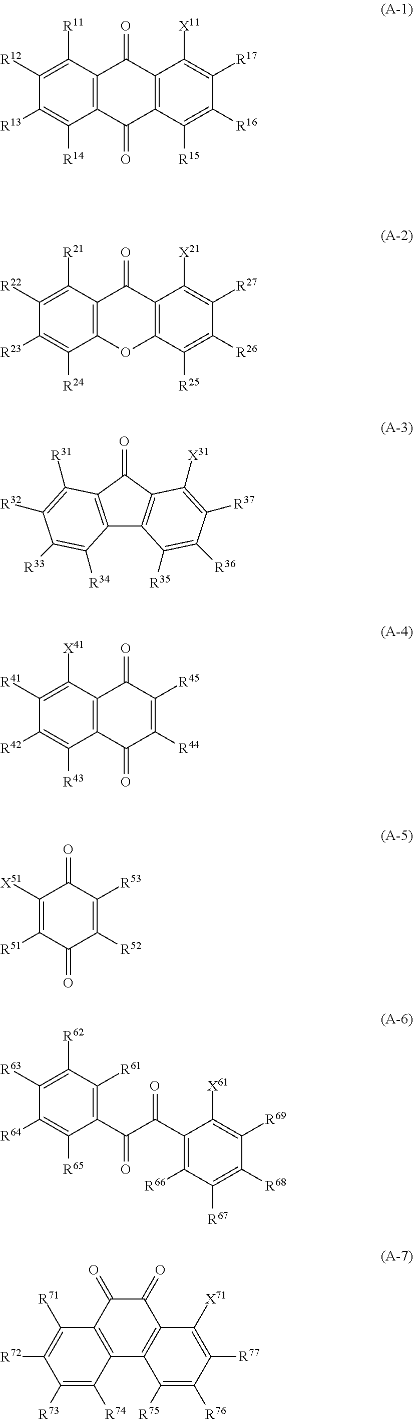

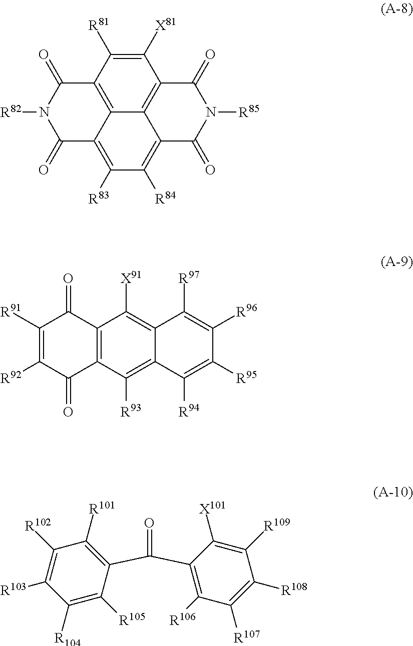

wherein, in the formulae (A-1) to (A-10), X¹¹, X²¹, X³¹, X⁴¹, X⁵¹, X⁶¹, X⁷¹, X⁸¹, X⁹¹, and X¹⁰¹ each independently represent an amino group, a hydroxy group, a carboxyl group, a group represented by —COONa, a group represented by —COOK, a sulfo group, or a thiol group, R¹¹ to R¹⁷, R²¹ to R²⁷, R³¹ to R³⁷, R⁴¹ to R⁴⁵, R⁵¹ to R⁵³, R⁶¹ to R⁶⁹, R⁷¹ to R⁷⁷ and R⁸¹ to R⁸⁵, R⁹¹ to R⁹⁷ and R¹⁰¹ to R¹⁰⁹ each independently represent a hydrogen atom, a cyano group, a nitro group, a halogen atom, an alkoxycarbonyl group, a hydroxy group, a thiol group, an amino group, a carboxyl group, a methoxy group, an ethoxy group, —SO₃Na, —SO₃K, an unsubstituted or substituted alkyl group, a group derived from one of the carbon atoms in the main chain of an unsubstituted or substituted alkyl group substituted for an oxygen atom, a group derived from one of the carbon atoms in the main chain of an unsubstituted or substituted alkyl group substituted for a nitrogen atom, an unsubstituted or substituted aryl group, or an unsubstituted or substituted heterocyclic group, a substituent of the substituted alkyl group is an alkyl group, an aryl group, a halogen atom, or a carbonyl group, a substituent of the substituted aryl group and a substituent of the substituted heterocyclic group are a halogen atom, a nitro group, a cyano group, an alkyl group, an alkyl halide group, an alkoxy group, or a carbonyl group,

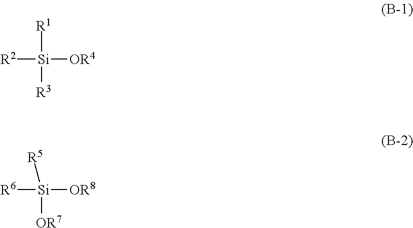

wherein, in the formulae (B-1) and (B-2), R¹, R², R³, R⁵, and R⁶ each independently represent an alkyl group having 1 to 10 carbon atoms, and R⁴, R⁷, and R⁸ each independently represent a methyl group, an ethyl group, or a phenyl group.

Aspects of the present invention provide a method for producing an electrophotographic photosensitive member including a support and an undercoat layer on the support, the method including

forming a coating film of an undercoat layer coating liquid containing a metal oxide particle, and
dying the coating film to form the undercoat layer.

The metal oxide particle contains on its surface

a compound represented by any one of the formulae (A-1) to (A-10), and
a compound represented by any one of the formulae (B-1) and (B-2).

Aspects of the present invention provide a process cartridge that can be attached to and detached from a main body of an electrophotographic apparatus, the process cartridge including

the electrophotographic photosensitive member, and
at least one device selected from the group consisting of a charging device, a developing device, a transfer device, and
a cleaning device,
wherein the electrophotographic photosensitive member and the at least one device are integrally supported.

Aspects of the present invention provide an electrophotographic apparatus that includes the electrophotographic photosensitive member, a charging device, a developing device, and a transfer device.

Aspects of the present invention can provide an electrophotographic photosensitive member that has reduced variations in electric potential during a repeated image forming period and a method for producing the electrophotographic photosensitive member. Aspects of the present invention can also provide a process cartridge and an electrophotographic apparatus each including the electrophotographic photosensitive member.

Further features of the present invention will become apparent from the following description of exemplary embodiments with reference to the attached drawings.

### BRIEF DESCRIPTION OF THE DRAWINGS

FIG. 1 is a schematic view of an electrophotographic apparatus that includes a process cartridge including an electrophotographic photosensitive member according to an embodiment of the present invention.

FIG. 2 is a schematic view of a layer structure of an electrophotographic photosensitive member according to an embodiment of the present invention.

### DESCRIPTION OF THE EMBODIMENTS

An electrophotographic photosensitive member according to an embodiment of the present invention includes a support and an undercoat layer on the support. The undercoat layer contains a metal oxide particle. The metal oxide particle contains a compound represented by any one of the formulae (A-1) to (A-10) and a compound represented by any one of the formulae (B-1) and (B-2) on the surface thereof.

The metal oxide particle containing the compounds on the surface thereof refers to a metal oxide particle whose surface has been treated with the compound represented by any one of the formulae (A-1) to (A-10) and with the compound represented by any one of the formulae (B-1) and (B-2).

The present inventor surmises the reason that such an electrophotographic photosensitive member has reduced variations in electric potential during a repeated image forming period as described below.

The compound represented by any one of the formulae (B-1) and (B-2) is an alkylalkoxysilane having one or two alkoxy groups. On the basis of study results, it was found that among alkylalkoxysilanes, generally used alkyltrialkoxysilanes having three alkoxy groups cannot effectively suppress electric potential variations. It is supposed that because alkyltrialkoxysilanes have three reaction sites, each silane molecule binds to adjacent two silane molecules and a metal oxide particle, thereby forming a three-dimensional network structure of silane molecules on the surface of the metal oxide particle. The three-dimensional network structure may block an electron-transport material for reducing variations in electric potential from being adsorbed on the surface of the metal oxide particle, resulting in insufficient surface treatment of the metal oxide particle with the electron-transport material.

In the case of alkylalkoxysilanes having one or two alkoxy groups according to an embodiment of the present invention, silane molecules are present alone on the surface of a metal oxide particle or form lines or circles on the surface of a metal oxide particle. Thus, an electron-transport material can be adsorbed on the surface of the metal oxide particle, and the surface of the metal oxide particle can be effectively treated with the electron-transport material. This results in reduced variations in electric potential during a repeated image forming period.

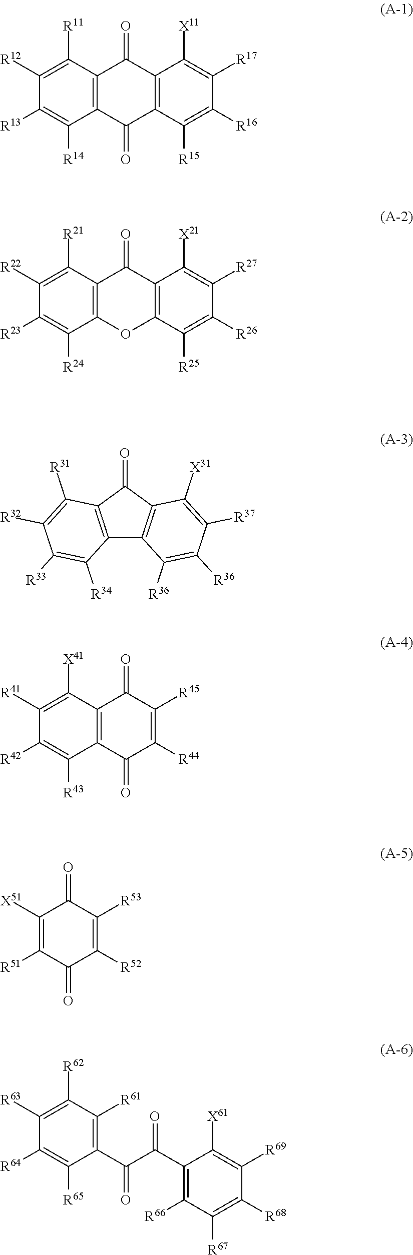

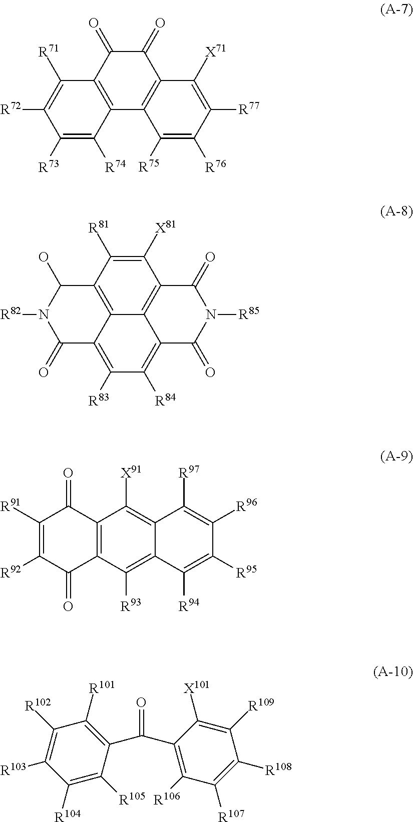

In the formulae (A-1) to (A-10), X¹¹, X²¹, X³¹, X⁴¹, X⁵¹, X⁶¹, X⁷¹, X⁸¹, X⁹¹, and X¹⁰¹ each independently represent an amino group, a hydroxy group, a carboxyl group, a group represented by —COONa, a group represented by —COOK, a sulfo group, or a thiol group, R¹¹ to R¹⁷, R²¹ to R²⁷, R³¹ to R³⁷, R⁴¹ to R⁴⁵, R⁵¹ to R⁵³, R⁶¹ to R⁶⁹, R⁷¹ to R⁷⁷ and R⁸¹ to R⁸⁵, R⁹¹ to R⁹⁷ and R¹⁰¹ to R¹⁰⁹ each independently represent a hydrogen atom, a cyano group, a nitro group, a halogen atom, an alkoxycarbonyl group, a hydroxy group, a thiol group, an amino group, a carboxyl group, a methoxy group, an ethoxy group, a group represented by —SO₃Na, a group represented by —SO₃K, an unsubstituted or substituted alkyl group, a group derived from one of the carbon atoms in the main chain of an unsubstituted or substituted alkyl group substituted for an oxygen atom, a group derived from one of the carbon atoms in the main chain of an unsubstituted or substituted alkyl group substituted for a nitrogen atom, an unsubstituted or substituted aryl group, or an unsubstituted or substituted heterocyclic group. A substituent of the substituted alkyl group is an alkyl group, an aryl group, a halogen atom, or a carbonyl group. A substituent of the substituted aryl group and a substituent of the substituted heterocyclic group are a halogen atom, a nitro group, a cyano group, an alkyl group, an alkyl halide group, an alkoxy group, or a carbonyl group.

The compounds represented by any one of the formulae (A-1) to (A-10) may be used alone or in combination.

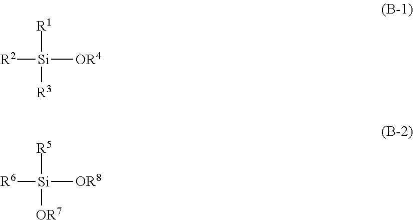

In the formulae (B-1) and (B-2), R¹, R², R³, R⁵, and R⁶ each independently represent an alkyl group having 1 to 10 carbon atoms. R⁴, R⁷, and R⁸ each independently represent a methyl group, an ethyl group, or a phenyl group. In order to reduce electric potential variations, R¹, R², R³, R⁵, and R⁶ can be an alkyl group having 1 to 5 carbon atoms.

Specific examples of the compounds represented by the formulae (A-1) to (A-10) are described below. However, the present invention is not limited to these examples.

TABLE 1

| | X¹¹ | R¹¹ | R¹² | R¹³ | R¹⁴ | R¹⁵ | R¹⁶ | R¹⁷ |
|---|---|---|---|---|---|---|---|---|
| (A-1-1) | —OH | —H | —H | —H | —H | —H | —H | —H |
| (A-1-2) | —OH | —H | —H | —H | —OH | —H | —H | —H |
| (A-1-3) | —OH | —OH | —H | —H | —H | —H | —H | —H |
| (A-1-4) | —OH | —H | —H | —H | —H | —OH | —H | —H |
| (A-1-5) | —OH | —H | —H | —H | —H | —H | —H | —OH |
| (A-1-6) | —OH | —H | —H | —H | —H | —OH | —H | —OH |
| (A-1-7) | —OH | —H | —H | —H | —H | —H | —CH₃ | —H |
| (A-1-8) | —OH | —H | —H | —H | —H | —H | —CH₂OH | —H |
| (A-1-9) | —NH₂ | —H | —H | —H | —H | —OH | —H | —H |
| (A-1-10) | —COOH | —H | —H | —H | —OH | —OH | —H | —H |
| (A-1-11) | —NH₂ | —OH | —H | —H | —NH₂ | —OH | —H | —H |
| (A-1-12) | —OH | —H | —H | —H | —H | —NO₂ | —H | —H |
| (A-1-13) | —NH₂ | —H | —H | —H | —H | —H | —H | —CH₃ |
| (A-1-14) | —NH₂ | —H | —H | —H | —H | —NH₂ | —CN | —CN |
| (A-1-15) | —NH₂ | —H | —H | —H | —H | —NH₂ | —Cl | —Cl |
| (A-1-16) | —NH₂ | —H | —H | —H | —H | —Br | —H | —SO₃Na |
| (A-1-17) | —SO₃Na | —H | —H | —H | —H | —H | —H | —H |

TABLE 2

| | X²¹ | R²¹ | R²² | R²³ | R²⁴ | R²⁵ | R²⁶ | R²⁷ |
|---|---|---|---|---|---|---|---|---|
| (A-2-1) | —OH | —H | —H | —H | —H | —H | —H | —H |
| (A-2-2) | —NH₂ | —H | —H | —H | —H | —H | —H | —H |
| (A-2-3) | —OH | —OH | —H | —H | —H | —H | —H | —H |
| (A-2-4) | —OH | —OH | —H | —H | —H | —OH | —H | —H |
| (A-2-5) | —OH | —H | —H | —H | —H | —H | —CH₃ | —H |
| (A-2-6) | —NH₂ | —H | —H | —H | —H | —Br | —H | —H |

TABLE 3

| | X³¹ | R³¹ | R³² | R³³ | R³⁴ | R³⁵ | R³⁶ | R³⁷ |
|---|---|---|---|---|---|---|---|---|
| (A-3-1) | —OH | —H | —H | —H | —H | —H | —H | —H |
| (A-3-2) | —COOH | —H | —H | —H | —H | —H | —H | —H |
| (A-3-3) | —OH | —OH | —H | —H | —H | —H | —H | —H |
| (A-3-4) | —OH | —H | —H | —H | —H | —H | —CH₃ | —H |
| (A-3-5) | —OH | —H | —H | —H | —H | —H | —Br | —H |
| (A-3-6) | —NH₂ | —NH₂ | —H | —H | —H | —H | —H | —H |

TABLE 4

| | X⁴¹ | R⁴¹ | R⁴² | R⁴³ | R⁴⁴ | R⁴⁵ |
|---|---|---|---|---|---|---|
| (A-4-1) | —OH | —H | —H | —H | —H | —H |
| (A-4-2) | —OH | —H | —H | —OH | —H | —H |
| (A-4-3) | —OH | —H | —H | —H | —H | —CH₃ |
| (A-4-4) | —OH | —H | —H | —OH | —Cl | —Cl |

TABLE 5

| | X⁵¹ | R⁵¹ | R⁵² | R⁵³ |
|---|---|---|---|---|
| (A-5-1) | —OH | —H | —OH | —H |
| (A-5-2) | —OH | —OH | —OH | —OH |
| (A-5-3) | —OH | —Br | —OH | —Br |
| (A-5-4) | —OH | —Cl | —OH | —Cl |
| (A-5-5) | —OH | —H | —OCH₃ | —H |

TABLE 6

| | X⁶¹ | R⁶¹ | R⁶² | R⁶³ | R⁶⁴ | R⁶⁵ | R⁶⁶ | R⁶⁷ | R⁶⁸ | R⁶⁹ |
|---|---|---|---|---|---|---|---|---|---|---|
| (A-6-1) | —OH | —H | —H | —H | —H | —H | —H | —H | —H | —H |
| (A-6-2) | —OH | —H | —H | —OH | —H | —H | —H | —H | —OH | —H |
| (A-6-3) | —NH₂ | —H | —H | —NH₂ | —H | —H | —H | —H | —NH₂ | —H |
| (A-6-4) | —OH | —H | —H | —CH₃ | —H | —H | —H | —H | —CH₃ | —H |
| (A-6-5) | —COOH | —H | —H | —COOH | —H | —H | —H | —H | —COOH | —H |
| (A-6-6) | —OH | —H | —H | —OH | —H | —OH | —H | —H | —OH | —H |

TABLE 7

| | X⁷¹ | R⁷¹ | R⁷² | R⁷³ | R⁷⁴ | R⁷⁵ | R⁷⁶ | R⁷⁷ |
|---|---|---|---|---|---|---|---|---|
| (A-7-1) | —OH | —H | —H | —H | —H | —H | —H | —H |
| (A-7-2) | —OH | —H | —H | —H | —H | —H | —OH | —H |
| (A-7-3) | —NH₂ | —H | —H | —H | —H | —H | —NH₂ | —H |
| (A-7-4) | —OH | —H | —H | —H | —H | —H | —Br | —H |

TABLE 8

| | X⁸¹ | R⁸¹ | R⁸² | R⁸³ | R⁸⁴ | R⁸⁵ |
|---|---|---|---|---|---|---|
| (A-8-1) | —OH | —H | —COOH | —H | —H | —COOH |
| (A-8-2) | —OH | —OH | —H2 | —H | —H | —H₂ |
| (A-8-3) | —NH₂ | —NH₂ | —COOH | —H | —H | —COOH |
| (A-8-4) | —COOH | —H | —COOH | —H | —H | —COOH |

TABLE 9

| | X⁹¹ | R⁹¹ | R⁹² | R⁹³ | R⁹⁴ | R⁹⁵ | R⁹⁶ | R⁹⁷ |
|---|---|---|---|---|---|---|---|---|
| (A-9-1) | —OH | —H | —H | —OH | —H | —H | —H | —H |
| (A-9-2) | —OH | —H | —H | —H | —H | —Br | —H | —H |
| (A-9-3) | —OH | —H | —H | —OH | —H | —H | —H | —H |
| (A-9-4) | —OH | —H | —H | —H | —H | —Br | —Br | —H |

TABLE 10

| | X¹⁰¹ | R¹⁰¹ | R¹⁰² | R¹⁰³ | R¹⁰⁴ | R¹⁰⁵ | R¹⁰⁶ | R¹⁰⁷ | R¹⁰⁸ | R¹⁰⁹ |
|---|---|---|---|---|---|---|---|---|---|---|
| (A-10-1) | —OH | —H | —H | —H | —H | —H | —OH | —OH | —H | —H |
| (A-10-2) | —OH | —H | —H | —H | —H | —H | —H | —OH | —H | —H |
| (A-10-3) | —OH | —OH | —H | —H | —H | —H | —H | —H | —H | —H |
| (A-10-4) | —OH | —H | —H | —H | —H | —H | —H | —H | —H | —H |

The compound represented by any one of the formulae (B-1) and (B-2) may be as follows: dimethyldimethoxysilane, dimethyldiethoxysilane, trimethylmethoxysilane, diethyldimethoxysilane, diethyldiethoxysilane, triethylethoxysilane, diisopropyldimethoxysilane, diisobutyldimethoxysilane, or cyclohexylmethyldimethoxysilane. The compounds represented by the formulae (B-1) and (B-2) may be used alone or in combination.

A surface-treated metal oxide particle can satisfy the following formula (1):

14≦S≦25(m²/g) (1)

wherein S represents a specific surface area (m²/g) of the metal oxide particle.

The metal oxide particle can also satisfy the following formulae (2) and (3):

0.02≦(A+B)≦0.40 (2)

0.01≦B/A≦1.0 (3)

wherein A represents a ratio of a mass of a compound represented by any one of the formulae (A-1) to (A-10) to a specific surface area S of the metal oxide particle, and B represents a ratio of a mass of a compound represented by any one of the formulae (B-1) and (B-2) to a specific surface area S of the metal oxide particle.

In the formula (2), (A+B) of 0.02 or more results in a sufficient interaction between the compound and the metal oxide particle and a significant reduction of electric potential variations during repeated use. (A+B) of 0.40 or less results in a reduced interaction between the compounds and consequently a significant reduction of electric potential variations during repeated use.

In the formula (3), B/A of 0.01 or more results in an appropriate interaction between the metal oxide particles, a smooth electron flow, and reduced electric potential variations during repeated use. B/A of 1.0 or less results in an appropriate ratio of the amount of compound represented by any one of the formulae (A-1) to (A-10) to the amount of compound represented by any one of the formulae (B-1) and (B-2) on the surface of the metal oxide particle and further reduced electric potential variations during repeated use. More preferably, B/A is 0.07 or more and 1.0 or less.

The metal oxide particle for use in the undercoat layer may be a metal oxide, such as titanium oxide, zinc oxide, tin oxide, zirconium oxide, or aluminum oxide. Among these, the metal oxide particle can be a particle containing at least one selected from the group consisting of zinc oxide and titanium oxide. The metal oxide particle can be a zinc oxide particle.

A metal oxide particle containing a compound represented by any one of the formulae (A-1) to (A-10) on the surface thereof is produced, for example, by mixing a metal oxide particle and the compound represented by any one of the formulae (A-1) to (A-10). The mixing may be performed by any general method, for example, by agitating the compound represented by any one of the formulae (A-1) to (A-10) and the metal oxide particle in a solvent. The type of solvent and the agitation conditions are not particularly limited.

The surface of the metal oxide particle may be treated with a compound represented by any one of the formulae (B-1) and (B-2) by any known method, for example, by a dry method or a wet method. In the dry method, an alcohol aqueous solution of a compound represented by any one of the formulae (B-1) and (B-2) and a solvent are added to the metal oxide particle in a high-speed mixer, such as a Henschel mixer, while stirring, are uniformly dispersed, and are then dried. In the wet method, the metal oxide particle and an alkylalkoxysilane in a solvent are agitated or dispersed, for example, with glass beads in a sand mill. The dispersion is followed by filtration or to evaporation under reduced pressure to remove the solvent. After the solvent is removed, baking can be performed at 100° C. or more.

The metal oxide particle preferably has a specific surface area S of 14 m²/g or more and 25 m²/g or less. A specific surface area S in this range tends to result in a uniformly dispersed state of the metal oxide particle and stable properties of the undercoat layer.

The specific surface area of the metal oxide particle can be measured with Shimadzu Corporation Tristar 3000. More specifically, 200 mg of the metal oxide particle in a measuring glass cell is dried at 150° C. under vacuum for 30 minutes as a pretreatment. The cell is then placed in the apparatus, and the specific surface area is measured.

The metal oxide particle may be a mixture of different types of metal oxides, metal oxides subjected to different surface treatments, or metal oxides having different specific surface areas.

The layer structure of an electrophotographic photosensitive member according to an embodiment of the present invention will be described below. An electrophotographic photosensitive member according to an embodiment of the present invention includes a support and an undercoat layer on the support. A photosensitive layer is disposed on the undercoat layer. The photosensitive layer can be a multilayer (function-separated) photosensitive layer composed of a charge-generating layer containing a charge-generation material and a charge-transport layer containing a charge-transport material.

FIG. 2 is a schematic view of a layer structure of an electrophotographic photosensitive member according to an embodiment of the present invention. In FIG. 2, the layer structure includes a support 21, an undercoat layer 22, a charge-generating layer 23, and a charge-transport layer (hole-transport layer) 24.

### Support

The support can be electrically conductive (an electrically conductive support). For example, the support is a metallic support made of a metal or alloy, such as aluminum, an aluminum alloy, or stainless steel. The support may also be a metallic or plastic support having an aluminum, aluminum alloy, or indium oxide-tin oxide alloy layer formed by vacuum evaporation. The support may also be a plastic or paper support impregnated with a conductive particle, such as carbon black, a tin oxide particle, a titanium oxide particle, or a silver particle, together with a binder resin. The support may also be a plastic support containing a conductive binder resin. The support may be cylindrical or belt-like.

In order to reduce interference fringes resulting from scattering of a laser beam, the surface of the support may be subjected to cutting, surface roughening, or alumite treatment.

A conductive layer for reducing interference fringes resulting from laser beam scattering or for covering scratches of the support may be disposed between the support and the undercoat layer. The conductive layer may be formed by dispersing carbon black or a conductive particle in a binder resin. The conductive layer preferably has a thickness in the range of 5 to 40 μm, more preferably 10 to 30 μm.

### Undercoat Layer

The undercoat layer is disposed between the support or the conductive layer and the photosensitive layer (the charge-generating layer or the charge-transport layer).

The undercoat layer can contain a binder resin, if necessary. The binder resin may be any known resin, for example, a cured resin. Cured resins dissolve negligibly in the upper layer during the formation of the photosensitive layer and cause small electrical resistance variations.

Examples of the cured resins include, but are not limited to, phenolic resin, polyurethane resin, epoxy resin, acrylic resin, melamine resin, and polyester resin. The cured resin can be a polyurethane resin formed by curing of a blocked isocyanate compound and a polyol.

Examples of the blocked isocyanate compound include, but are not limited to, oxime-blocked 2,4-tolylene diisocyanate, 2,6-tolylene diisocyanate, diphenylmethane-4,4′-diisocyanate, hexamethylene diisocyanate (HDI), HDI-trimethylolpropane adducts, HDI-isocyanurate, and HDI-biuret. Examples of the oxime include, but are not limited to, formaldehyde oxime, acetaldoxime, methyl ethyl ketoxime, and cyclohexanone oxime. Examples of the polyol include, but are not limited to, polyether polyols, polyester polyols, acrylic polyols, epoxy polyols, and fluorinated polyols.

The undercoat layer may contain an organic resin fine particle and/or a leveling agent, if necessary.

Examples of the organic resin particle include, but are not limited to, a hydrophobic organic resin particle, such as a silicone particle, and a hydrophilic organic resin particle, such as a cross-linked polymethacrylate resin (PMMA) particle. In particular, a PMMA particle can be used to appropriately control the surface roughness of the undercoat layer. The undercoat layer may have surface roughness Rz in the range of 0.6 to 2.0 μm and Sm in the range of 0.010 to 0.024 mm. Sm in this range indicates fine pitch surface roughness and results in improved adhesion between the undercoat layer and the charge-generating layer.

The undercoat layer may be applied by a coating method, such as a dip coating method, a spray coating method, a spinner coating method, a bead coating method, a blade coating method, or a beam coating method. The undercoat layer may be dried by heat drying and/or air drying. The heating temperature depends on the resin curing temperature and may be determined so as to achieve desired characteristics of the electrophotographic photosensitive member.

The undercoat layer preferably has a thickness in the range of approximately 0.5 to 30 μm, more preferably 10 to 30 μm.

### Photosensitive Layer

The photosensitive layer (the charge-generating layer and the charge-transport layer) is disposed on the undercoat layer.

Examples of the charge-generation material include, but are not limited to, azo pigments, phthalocyanine pigments, indigo pigments, perylene pigments, polycyclic quinone pigments, squarylium dyes, pyrylium salts, thiapyrylium salts, triphenylmethane dyes, quinacridone pigments, azulenium salt pigments, cyanine dyes, anthanthrone pigments, pyranthrone pigments, xanthene dyes, quinonimine dyes, and styryl dyes. These charge-generation materials may be used alone or in combination.

Among these charge-generation materials, phthalocyanine pigments and azo pigments, particularly phthalocyanine pigments, have high sensitivity.

Among the phthalocyanine pigments, oxytitanium phthalocyanines, chlorogallium phthalocyanines, and hydroxygallium phthalocyanines have high charge generation efficiency.

Among hydroxygallium phthalocyanines, hydroxygallium phthalocyanine crystals having peaks at Bragg angles 2θ of 7.4±0.3 degrees and 28.2±0.3 degrees in CuKα characteristic X-ray diffractometry have good potential characteristics.

In the case that the photosensitive layer is a multi-layer type photosensitive layer, the charge-generating layer can be formed by dispersing a charge-generation material and a binder resin in a solvent to prepare a charge-generating layer coating liquid, applying the charge-generating layer coating liquid to form a coating film, and drying the coating film.

Examples of the binder resin for use in the charge-generating layer include, but are not limited to, acrylic resin, allyl resin, alkyd resin, epoxy resin, diallyl phthalate resin, styrene-butadiene copolymers, butyral resin, benzal resin, polyacrylate, polyacetal, polyamideimide, polyamide, poly(allyl ether), polyarylate, polyimide, polyurethane, polyester, polyethylene, polycarbonate, polystyrene, polysulfone, poly(vinyl acetal), polybutadiene, polypropylene, methacrylate resin, urea resin, vinyl chloride-vinyl acetate copolymers, poly(vinyl acetate) resin, and poly(vinyl chloride) resin. Among these, the binder resin can be a butyral resin. These may be used alone or in combination as a mixture or copolymer.

The dispersion may be performed with a homogenizer, an ultrasonic homogenizer, a ball mill, a sand mill, a rolling mill, a vibrating mill, an attritor, or a liquid-collision high-speed disperser. The mass ratio of the charge-generation material to the binder resin in the charge-generating layer preferably ranges from 0.3:1 to 10:1.

Examples of the solvent for use in the charge-generating layer coating liquid include, but are not limited to, alcohols, sulfoxides, ketones, ethers, esters, aliphatic halogenated hydrocarbons, and aromatic compounds.

The charge-generating layer preferably has a thickness of 5 μm or less, more preferably 0.1 μm or more and 2 μm or less. The charge-generating layer may contain a sensitizer, an antioxidant, an ultraviolet absorber, and/or a plasticizer, if necessary.

In an electrophotographic photosensitive member including a multi-layer type photosensitive layer, a charge-transport layer is formed on the charge-generating layer. The charge-transport layer can be formed by dissolving a charge-transport material and a binder resin in a solvent to prepare a charge-transport layer coating liquid, applying the charge-transport layer coating liquid to form a coating film, and drying the coating film.

Examples of the charge-transport material include, but are not limited to, triarylamine compounds, hydrazone compounds, styryl compounds, stilbene compounds, and butadiene compounds. Among these, the charge-transport material can be a triarylamine compound.

In the case that the photosensitive layer is a multi-layer type photosensitive layer, a binder resin for use in the charge-transport layer may be an acrylic resin, acrylonitrile resin, allyl resin, alkyd resin, epoxy resin, silicone resin, phenolic resin, phenoxy resin, polyacrylamide, polyamideimide, polyamide, poly(allyl ether), polyarylate, polyimide, polyurethane, polyester, polyethylene, polycarbonate, polysulfone, poly(phenylene oxide), polybutadiene, polypropylene, or methacrylate resin. In particular, the binder resin can be polyarylate or polycarbonate. These may be used alone or in combination as a mixture or copolymer.

The mass ratio of the charge-transport material to the binder resin preferably ranges from 0.3:1 to 10:1. In order to suppress cracking, the drying temperature of the coating film of the charge-transport layer coating liquid is preferably 60° C. or more and 150° C. or less, more preferably 80° C. or more and 120° C. or less. The drying time is preferably 10 minutes or more and 60 minutes or less.

The solvent for use in the charge-transport layer coating liquid may be an alcohol (particularly an alcohol having 3 or more carbon atoms), such as propanol or butanol, an aromatic hydrocarbon, such as anisole, toluene, xylene, or chlorobenzene, methylcyclohexane, or ethylcyclohexane.

In the case that the charge-transport layer has a multilayer structure, a layer of the charge-transport layer on the outer surface of the electrophotographic photosensitive member can be formed by curing a charge-transport material having a chain polymerizable functional group by polymerization (cross-linking) in order to increase the mechanical strength of the electrophotographic photosensitive member. The chain polymerizable functional group may be an acryl group, an alkoxysilyl group, or an epoxy group. A charge-transport material having a chain polymerizable functional group can be polymerized and/or cross-linked by heat, light, and/or radiation (electron beam).

In the case that the electrophotographic photosensitive member includes a monolayer charge-transport layer, the charge-transport layer preferably has a thickness of 5 μm or more and 40 μm or less, more preferably 8 μm or more and 30 μm or less.

In the case that the charge-transport layer has a multilayer structure, a layer of the charge-transport layer adjacent to the support of the electrophotographic photosensitive member preferably has a thickness of 5 μm or more and 30 μm or less, and a layer of the charge-transport layer on the outer surface of the electrophotographic photosensitive member preferably has a thickness of 1 μm or more and 10 μm or less.

The charge-transport layer may contain an antioxidant, an ultraviolet absorber, and/or a plasticizer, if necessary.

A protective layer for protecting the photosensitive layer may be disposed on the photosensitive layer. The protective layer can be formed by dissolving a binder resin in a solvent to prepare a protective layer coating liquid and applying and drying the protective layer coating liquid. The protective layer may also be formed by dissolving a resin monomer or oligomer in a solvent to prepare a protective layer coating liquid, applying the protective layer coating liquid, and curing and/or drying the protective layer coating liquid. The protective layer coating liquid can be cured by light, heat, or radiation (electron beam).

The protective layer preferably has a thickness of 0.5 μm or more and 10 μm or less, more preferably 1 μm or more and 7 μm or less. The protective layer may contain a conductive particle, if necessary.

These coating liquids may be applied by a coating method, such as a dip coating method, a spray coating method, a spinner coating method, a roller coating method, a Mayer bar coating method, or a blade coating method.

The outermost surface layer (surface layer) of the electrophotographic photosensitive member may contain a lubricant, such as silicone oil, wax, a polytetrafluoroethylene particle, a silica particle, an alumina particle, and/or boron nitride.

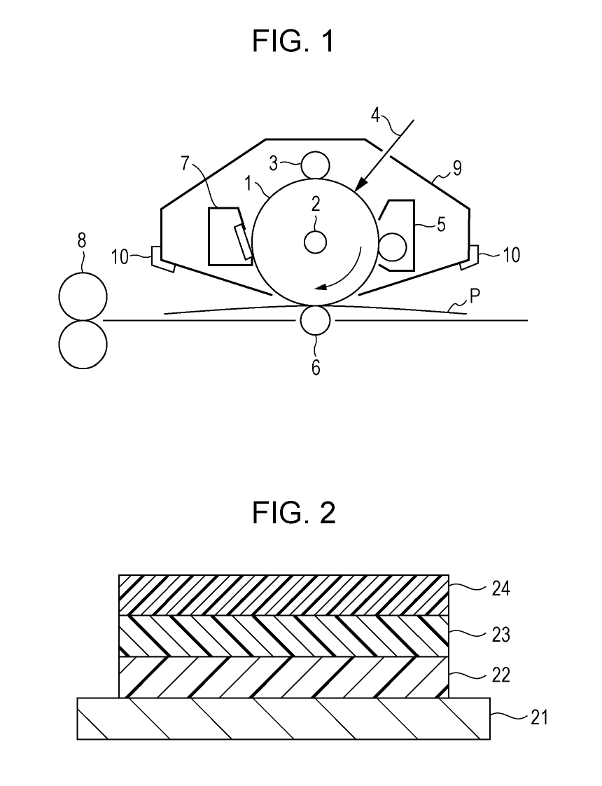

FIG. 1 illustrates an electrophotographic apparatus that includes a process cartridge including an electrophotographic photosensitive member according to an embodiment of the present invention.

In FIG. 1, a cylindrical (drum-type) electrophotographic photosensitive member 1 according to an embodiment of the present invention is rotated on a shaft 2 in the direction of the arrow at a predetermined circumferential velocity (process speed).

The surface of the electrophotographic photosensitive member 1 is charged to a predetermined positive or negative potential with a charging device 3 (a primary charge member, such as a charging roller) during rotation.

The surface of the electrophotographic photosensitive member 1 is then irradiated with exposure light (image exposure light) 4 emitted from an exposure device (image exposure device) (not shown). Thus, an electrostatic latent image is formed on the surface of the electrophotographic photosensitive member 1.

The electrostatic latent image on the surface of the electrophotographic photosensitive member 1 is then developed (normal development or reversal development) with a developer (toner) in a developing device 5, thus forming a toner image on the surface of the electrophotographic photosensitive member 1. The toner image on the surface of the electrophotographic photosensitive member 1 is then transferred to a transfer material P by a transfer device 6 (transfer roller).

The transfer material P is fed from a transfer material supply unit (not shown) to a contact portion between the electrophotographic photosensitive member 1 and the transfer device 6 in synchronism with the rotation of the electrophotographic photosensitive member 1.

A voltage (transfer bias) having polarity opposite to the polarity of the electric charge of the toner is applied to the transfer device 6 with a bias power supply (not shown).

The transfer material P to which the toner image is transferred is then separated from the surface of the electrophotographic photosensitive member 1 and is transported to a fixing device 8. After the toner image is fixed, the transfer material P is output from the electrophotographic apparatus as an image-formed article (such as a print or copy). The transfer device 6 may be an intermediate transfer system composed of a primary transfer member, an intermediate transfer member, and a secondary transfer member.

The surface of the electrophotographic photosensitive member 1 after the toner image has been transferred to the transfer material P is cleaned with a cleaning device 7 (cleaning blade), thereby removing deposits, such as a residual developer (residual toner), from the surface. The residual toner may be recovered with the developing device 5 (a cleaner-less system).

The surface of the electrophotographic photosensitive member 1 is irradiated with pre-exposure light (not shown) emitted from a pre-exposure device (not shown) to remove electricity. The electrophotographic photosensitive member 1 is again used for image formation. In the case that the charging device 3 is a contact charging device, such as a charging roller, as illustrated in FIG. 1, pre-exposure is not necessarily required.

At least two of the electrophotographic photosensitive member 1, the charging device 3, the developing device 5, the transfer device 6, and the cleaning device 7 can be housed in a container and used as a process cartridge.

The process cartridge can be detachably attached to the main body of the electrophotographic apparatus. For example, the electrophotographic photosensitive member 1 and at least one of the charging device 3, the developing device 5, the transfer device 6, and the cleaning device 7 are integrally supported to form a cartridge. The cartridge may be a process cartridge 9 that can be attached to and detached from the main body of the electrophotographic apparatus through a guide 10, such as a rail, for the main body of the electrophotographic apparatus.

The exposure light 4 may be reflected light from an original or transmitted light through an original, or may be light emitted by reading an original with a sensor, converting the reading to signals, and scanning a laser beam, driving an LED array, or driving a liquid crystal shutter array in response to the signals.

### EXAMPLES

The present invention will be further described with exemplary embodiments. However, the present invention is not limited to these exemplary embodiments. In the exemplary embodiments, “%” and “parts” refer to “% by mass” and “parts by mass”, respectively.

### Exemplary Embodiment 1

100 parts of a zinc oxide particle (specific surface area: 18.8 m²/g, powder resistance: 4.9×10⁶ Ω·cm, purity: 98.5%) was mixed with 500 parts of toluene. 0.75 parts of dimethyldimethoxysilane (trade name: KBM-22, manufactured by Shin-Etsu Chemical Co., Ltd.) was added to the mixture. The mixture was agitated for 6 hours. Toluene was then evaporated under reduced pressure. The mixture was dried at 140° C. for 6 hours, thus yielding a zinc oxide particle whose surface has been treated with a compound represented by the formula (B-2).

The following materials were dispersed with glass beads having a diameter of 0.8 mm in a sand mill for 3 hours.

| | |
|---|---|
| The surface-treated zinc oxide particle | 81 parts |
| Exemplary compound (A-1-1) | 0.5 parts |
| Blocked isocyanate (trade name: Sumidur 3175, | 15 parts |
| manufactured by Sumika Bayer Urethane Co., Ltd.) | |
| A mixed solution of 15 parts of butyral resin (trade name: | 100 parts |
| BM-1, manufactured by Sekisui Chemical Co., Ltd.), 70.0 | |
| parts of methyl ethyl ketone, and 30.0 parts of 1-butanol | |
| Methyl ethyl ketone | 40.6 parts |
| 1-butanol | 17.4 parts |

After the dispersion, 0.01 parts of silicone oil SH28PA (manufactured by Dow Corning Toray Silicone Co., Ltd.) and 5.6 parts of a poly(methyl methacrylate) resin particle (PMMA, manufactured by Sekisui Plastics Co., Ltd., SSX-103, average particle diameter 3.5 μm) were added to the dispersion liquid to prepare an undercoat layer coating liquid.

An aluminum cylinder (ED pipe) (manufactured by Showa Denko K.K., diameter 24 mm×length 357.5 mm, Rzjis=0.8 μm) was used as a support (conductive support). The undercoat layer coating liquid was applied to the support by dip coating and was dried at 160° C. for 30 minutes to form an undercoat layer having a thickness of 30 μm.

10 parts of hydroxygallium phthalocyanine crystals having peaks at Bragg angles 2θ±0.2 degrees of 7.4 degrees and 28.1 degrees in CuKα characteristic X-ray diffractometry, 0.1 parts of a compound represented by the following formula (A), and 5 parts of a poly(vinyl butyral) resin (trade name: S-Lec BX-1, manufactured by Sekisui Chemical Co., Ltd.) were added to 250 parts of cyclohexanone and were dispersed with glass beads having a diameter of 0.8 mm in a sand mill for 3 hours. The dispersion was diluted with 100 parts of cyclohexanone and 450 parts of ethyl acetate to prepare a charge-generating layer coating liquid. The coating liquid was applied to the undercoat layer by dip coating and was dried at 100° C. for 10 minutes to form a charge-generating layer having a thickness of 0.17 μm.

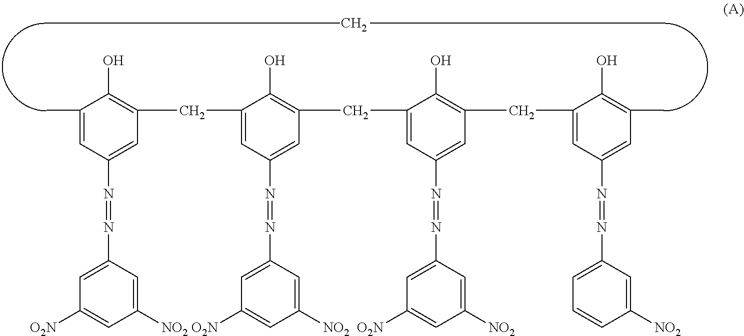

50 parts of a compound represented by the following formula (B) as a charge-transport material, 50 parts of a compound represented by the following formula (C), and 100 parts of a polycarbonate resin (trade name: Iupilon Z400, manufactured by Mitsubishi Gas Chemical Co., Inc.) were dissolved in a mixed solvent of 650 parts of monochlorobenzene and 150 parts of dimethoxymethane to prepare a charge-transport layer coating liquid. The charge-transport layer coating liquid was applied to the charge-generating layer by dip coating and was dried at 120° C. for 30 minutes to form a charge-transport layer having a thickness of 23 μm.

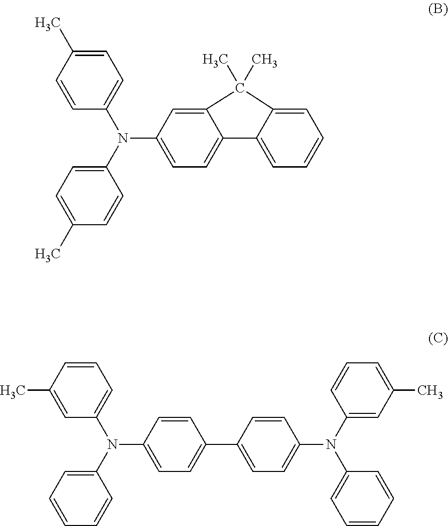

### Exemplary Embodiments 2 to 23

The metal oxide particle, the type and amount of the compound represented by any one of the formulae (A-1) to (A-10), and the type and amount of the compound represented by any one of the formulae (B-1) and (B-2) used in the preparation of the undercoat layer coating liquid in Exemplary Embodiment 1 were changes as listed in Table 11. Except for these, electrophotographic photosensitive members were produced in the same manner as in Exemplary Embodiment 1.

### Comparative Example 1

An electrophotographic photosensitive member was produced in the same manner as in Exemplary Embodiment 1 except that the exemplary compound (A-1-1) was not used.

### Comparative Example 2

An electrophotographic photosensitive member was produced in the same manner as in Exemplary Embodiment 1 except that dimethyldimethoxysilane was not used.

### Comparative Example 3

An electrophotographic photosensitive member was produced in the same manner as in Exemplary Embodiment 1 except that dimethyldimethoxysilane was replaced by methyltrimethoxysilane.

### Comparative Example 4

An electrophotographic photosensitive member was produced in the same manner as in Exemplary Embodiment 1 except that dimethyldimethoxysilane was replaced by phenyltriethoxysilane.

### Evaluation—Electric Potential Variations

The electrophotographic photosensitive members according to Exemplary Embodiments 1 to 23 and Comparative Examples 1 to 4 were evaluated as described below.

The electrophotographic apparatus used for the evaluation was a laser-beam printer LBP-2510 manufactured by CANON KABUSHIKI KAISHA modified as described below. That is, the charging conditions and the laser dose were made variable. Each of the electrophotographic photosensitive members was mounted in a cyan process cartridge. The cyan process cartridge was mounted in a cyan process cartridge station.

The charging conditions and the laser dose were determined such that the surface potential of the electrophotographic photosensitive member included an initial dark potential of −500 V and a bright potential of −160 V at a temperature of 25° C. and at a humidity of 20% RH. In the measurement of surface potential, the cartridge was modified such that a potential probe (trade name: model 6000B-8, manufactured by Trek Japan) was placed at a development position. The potential of a central portion of the electrophotographic photosensitive member was measured with a surface electrometer (trade name: model 344, manufactured by Trek Japan).

In the evaluation of electric potential variations, 15000 sheets of cyan images were output. During sheet passing, a text image was successively formed on A4-size plain paper sheets at a printing ratio of 1%. The dark potential and bright potential were measured at the start of image output and when 15000 sheets of the image were output. The dark potential variation (ΔVd) and bright potential variation (ΔVl) due to the output of 15000 sheets were determined from the differences between the initial dark potential and initial bright potential and the dark potential and bright potential when 15000 sheets of the image were output. Table 11 shows the results.

TABLE 11

| | | | | A = Treated | | B = Treated | | | | |
|---|---|---|---|---|---|---|---|---|---|---|
| | | Specific | | amount/ | Electron- | amount/ | | | | |
| | Type of | surface | | Specific | transport | Specific | A + | | | |
| Embodiments | metal oxide | area S | Alkylalkoxysilane | surface area | material | surface area | B | B/A | ΔVd | ΔVl |
| Exemplary embodiment 1 | Zinc oxide | 18.8 | Dimethyldimethoxysilane | 0.10 | A-1-1 | 0.05 | 0.15 | 0.50 | 5 | 6 |
| Exemplary embodiment 2 | Zinc oxide | 18.8 | Dimethyldiethoxysilane | 0.10 | A-1-4 | 0.05 | 0.15 | 0.50 | 8 | 5 |
| Exemplary embodiment 3 | Zinc oxide | 18.8 | Trimethylmethoxysilane | 0.10 | A-1-8 | 0.05 | 0.15 | 0.50 | 4 | 3 |
| Exemplary embodiment 4 | Zinc oxide | 18.8 | Diisopropyldimethoxysilane | 0.10 | A-1-10 | 0.05 | 0.15 | 0.50 | 6 | 5 |
| Exemplary embodiment 5 | Zinc oxide | 18.8 | Diisobutyldimethoxysilane | 0.10 | A-1-12 | 0.05 | 0.15 | 0.50 | 8 | 9 |
| Exemplary embodiment 6 | Zinc oxide | 18.8 | Cyclohexylmethyl- | 0.10 | A-1-16 | 0.05 | 0.15 | 0.50 | 12 | 11 |
| | | | dimethoxysilane | | | | | | | |
| Exemplary embodiment 7 | Zinc oxide | 15.5 | Dimethyldimethoxysilane | 0.10 | A-2-3 | 0.05 | 0.15 | 0.50 | 8 | 5 |
| Exemplary embodiment 8 | Zinc oxide | 14.2 | Dimethyldimethoxysilane | 0.10 | A-3-1 | 0.05 | 0.15 | 0.50 | 14 | 16 |
| Exemplary embodiment 9 | Zinc oxide | 13.5 | Dimethyldimethoxysilane | 0.10 | A-3-3 | 0.05 | 0.15 | 0.50 | 21 | 20 |
| Exemplary embodiment 10 | Zinc oxide | 22.5 | Dimethyldimethoxysilane | 0.10 | A-3-6 | 0.05 | 0.15 | 0.50 | 16 | 12 |
| Exemplary embodiment 11 | Zinc oxide | 24.6 | Dimethyldimethoxysilane | 0.10 | A-4-2 | 0.05 | 0.15 | 0.50 | 15 | 15 |
| Exemplary embodiment 12 | Zinc oxide | 27.3 | Dimethyldimethoxysilane | 0.10 | A-5-1 | 0.05 | 0.15 | 0.50 | 21 | 21 |
| Exemplary embodiment 13 | Zinc oxide | 18.8 | Dimethyldimethoxysilane | 0.03 | A-6-2 | 0.05 | 0.08 | 1.67 | 22 | 20 |
| Exemplary embodiment 14 | Zinc oxide | 18.8 | Dimethyldimethoxysilane | 0.01 | A-7-2 | 0.05 | 0.06 | 5.00 | 24 | 23 |
| Exemplary embodiment 15 | Zinc oxide | 18.8 | Dimethyldimethoxysilane | 0.15 | A-8-1 | 0.05 | 0.20 | 0.33 | 6 | 6 |
| Exemplary embodiment 16 | Zinc oxide | 18.8 | Dimethyldimethoxysilane | 0.10 | A-8-2 | 0.03 | 0.13 | 0.30 | 8 | 6 |
| Exemplary embodiment 17 | Zinc oxide | 18.8 | Dimethyldimethoxysilane | 0.005 | A-8-3 | 0.010 | 0.015 | 2.00 | 21 | 20 |
| Exemplary embodiment 18 | Zinc oxide | 18.8 | Dimethyldimethoxysilane | 0.10 | A-9-1 | 0.20 | 0.30 | 2.00 | 20 | 21 |
| Exemplary embodiment 19 | Zinc oxide | 18.8 | Dimethyldimethoxysilane | 0.01 | A-9-3 | 0.01 | 0.02 | 1.00 | 16 | 15 |
| Exemplary embodiment 20 | Zinc oxide | 18.8 | Dimethyldimethoxysilane | 0.01 | A-10-1 | 0.15 | 0.16 | 15.00 | 31 | 28 |
| Exemplary embodiment 21 | Zinc oxide | 18.8 | Dimethyldimethoxysilane | 0.15 | A-10-2 | 0.01 | 0.16 | 0.07 | 6 | 5 |
| Exemplary embodiment 22 | Zinc oxide | 18.8 | Dimethyldimethoxysilane | 0.25 | A-10-3 | 0.20 | 0.45 | 0.80 | 24 | 22 |
| Exemplary embodiment 23 | Titanium | 21.0 | Dimethyldimethoxysilane | 0.10 | A-10-4 | 0.10 | 0.20 | 1.00 | 16 | 17 |
| | oxide | | | | | | | | | |
| Comparative example 1 | Zinc oxide | 18.8 | Dimethyldimethoxysilane | 0.10 | — | — | 0.10 | — | 62 | 58 |
| Comparative example 2 | Zinc oxide | 18.8 | — | — | A-1-1 | 0.05 | 0.05 | — | 58 | 59 |
| Comparative example 3 | Zinc oxide | 18.8 | Methyltrimethoxysilane | 0.10 | A-1-1 | 0.05 | 0.15 | 0.50 | 48 | 44 |
| Comparative example 4 | Zinc oxide | 18.8 | Phenyltriethoxysilane | 0.10 | A-1-1 | 0.05 | 0.15 | 0.50 | 52 | 50 |

In Table 11, “Alkylalkoxysilane” refers to a compound represented by any one of the formulae (B-1) and (B-2).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2014-141767 filed Jul. 9, 2014 and No. 2015-109183 filed May 28, 2015, which are hereby incorporated by reference herein in their entirety.

What is claimed is:

1. An electrophotographic photosensitive member comprising:
a support; and
an undercoat layer on the support,
wherein the undercoat layer comprises a metal oxide particle whose surface contains:
a compound represented by any one of the following formulae (A-1) to (A-10); and
a compound represented by any one of the following formulae (B-1) and (B-2), 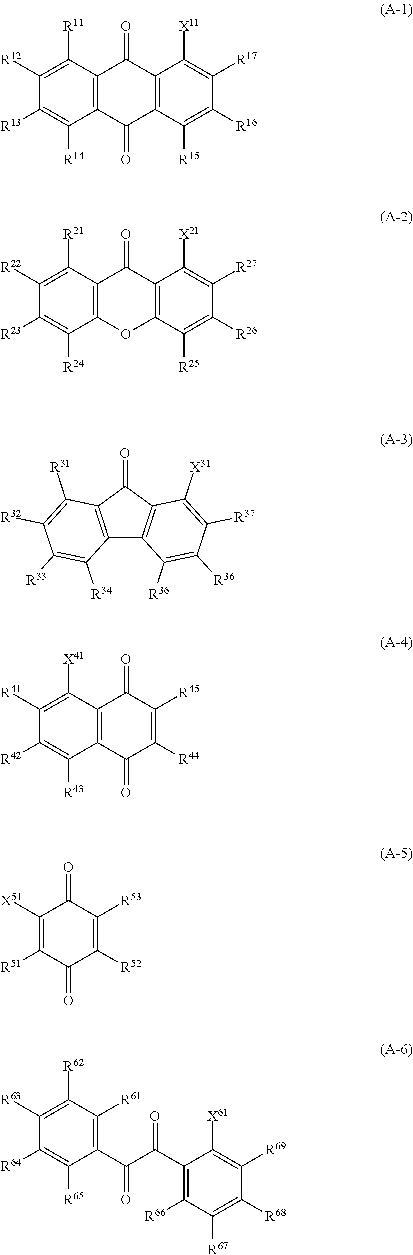 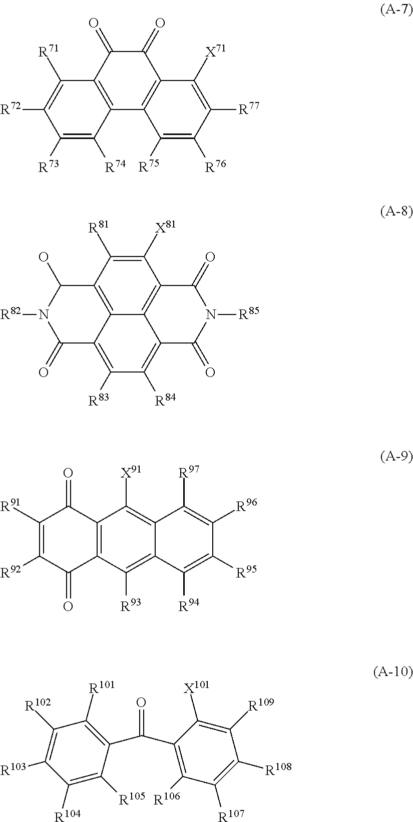
wherein, in the formulae (A-1) to (A-10), X¹¹, X²¹, X³¹, X⁴¹, X⁵¹, X⁶¹, X⁷¹, X⁸¹, X⁹¹, and X¹⁰¹ each independently represent an amino group, a hydroxy group, a carboxyl group, a group represented by —COONa, a group represented by —COOK, a sulfo group, or a thiol group,
R¹¹ to R¹⁷, R²¹ to R²⁷, R³¹ to R³⁷, R⁴¹ to R⁴⁵, R⁵¹ to R⁵³, R⁶¹ to R⁶⁹, R⁷¹ to R⁷⁷ and R⁸¹ to R⁸⁵, R⁹¹ to R⁹⁷ and R¹⁰¹ to R¹⁰⁹ each independently represent a hydrogen atom, a cyano group, a nitro group, a halogen atom, an alkoxycarbonyl group, a hydroxy group, a thiol group, an amino group, a carboxyl group, a methoxy group, an ethoxy group, a group represented by —SO₃Na, a group represented by —SO₃K, an unsubstituted or substituted alkyl group, a group derived from one of the carbon atoms in the main chain of an unsubstituted or substituted alkyl group substituted for an oxygen atom, a group derived from one of the carbon atoms in the main chain of an unsubstituted or substituted alkyl group substituted for a nitrogen atom, an unsubstituted or substituted aryl group, or an unsubstituted or substituted heterocyclic group,
a substituent of the substituted alkyl group is an alkyl group, an aryl group, a halogen atom, or a carbonyl group, a substituent of the substituted aryl group and a substituent of the substituted heterocyclic group are a halogen atom, a nitro group, a cyano group, an alkyl group, an alkyl halide group, an alkoxy group, or a carbonyl group, 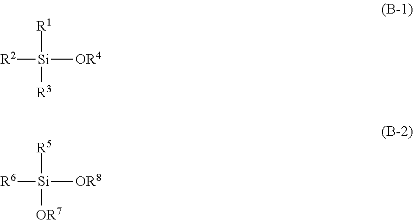
wherein, in the formulae (B-1) and (B-2), R¹, R², R³, R⁵, and R⁶ each independently represent an alkyl group having 1 to 10 carbon atoms, and R⁴, R⁷, and R⁸ each independently represent a methyl group, an ethyl group, or a phenyl group.

2. The electrophotographic photosensitive member according to claim 1, wherein the metal oxide particle satisfies the following formula (1):
14≦S≦25(m²/g) (1)
wherein S represents a specific surface area (m²/g) of the metal oxide particle.

3. The electrophotographic photosensitive member according to claim 1, wherein the metal oxide particle satisfies the formulae (2) and (3):
0.02≦(A+B)≦0.40 (2)
0.01≦B/A≦1.0 (3)
wherein A represents a ratio of a mass of a compound represented by any one of the formulae (A-1) to (A-10) to a specific surface area S of the metal oxide particle, and
B represents a ratio of a mass of a compound represented by any one of the formulae (B-1) and (B-2) to a specific surface area S of the metal oxide particle.

4. The electrophotographic photosensitive member according to claim 1, wherein the metal oxide particle is a metal oxide particle whose surface has been treated with a compound represented by any one of the formulae (A-1) to (A-10) and a compound represented by any one of the formulae (B-1) and (B-2).

5. The electrophotographic photosensitive member according to claim 1, wherein the metal oxide particle is a particle comprising at least one selected from the group consisting of zinc oxide and titanium oxide.

6. The electrophotographic photosensitive member according to claim 1, wherein R¹, R², R³, R⁵, and R⁶ in the formula (2) each independently represent an alkyl group having 1 to 5 carbon atoms.

7. A method for producing an electrophotographic photosensitive member comprising a support and an undercoat layer on the support, the method comprising:
forming a coating film of an undercoat layer coating liquid containing a metal oxide particle; and
dying the coating film to form the undercoat layer,
wherein the metal oxide particle contains on its surface:
a compound represented by any one of the following formulae (A-1) to (A-10); and
a compound represented by any one of the following formulae (B-1) and (B-2), 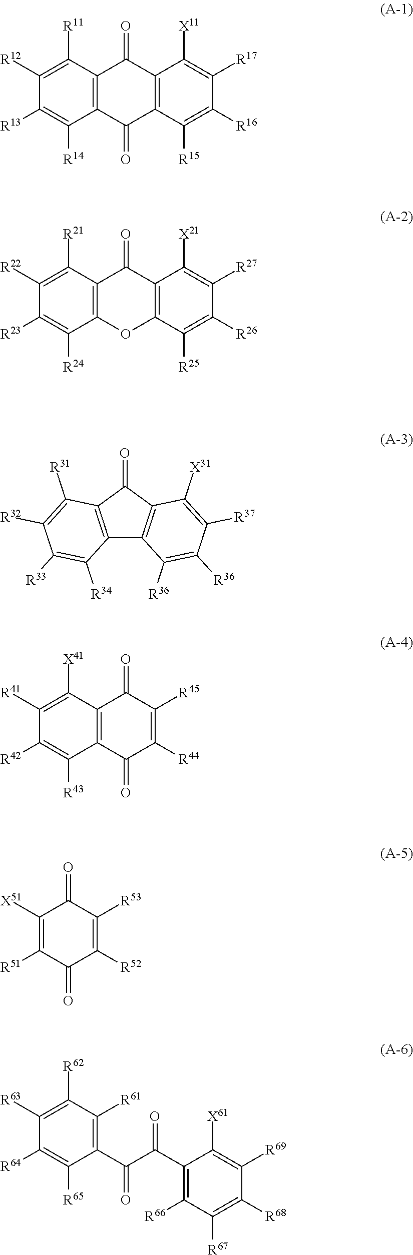 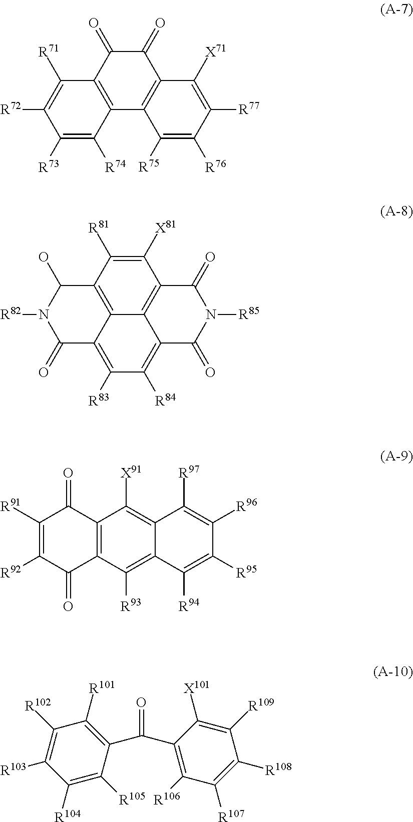
wherein, in the formulae (A-1) to (A-10), X¹¹, X²¹, X³¹, X⁴¹, X⁵¹, X⁶¹, X⁷¹, X⁸¹, X⁹¹, and X¹⁰¹ each independently represent an amino group, a hydroxy group, a carboxyl group, a group represented by —COONa, a group represented by —COOK, a sulfo group, or a thiol group,
R¹¹ to R¹⁷, R²¹ to R²⁷, R³¹ to R³⁷, R⁴¹ to R⁴⁵, R⁵¹ to R⁵³, R⁶¹ to R⁶⁹, R⁷¹ to R⁷⁷ and R⁸¹ to R⁸⁵, R⁹¹ to R⁹⁷ and R¹⁰¹ to R¹⁰⁹ each independently represent a hydrogen atom, a cyano group, a nitro group, a halogen atom, an alkoxycarbonyl group, a hydroxy group, a thiol group, an amino group, a carboxyl group, a methoxy group, an ethoxy group, a group represented by —SO₃Na, a group represented by —SO₃K, an unsubstituted or substituted alkyl group, a group derived from one of the carbon atoms in the main chain of an unsubstituted or substituted alkyl group substituted for an oxygen atom, a group derived from one of the carbon atoms in the main chain of an unsubstituted or substituted alkyl group substituted for a nitrogen atom, an unsubstituted or substituted aryl group, or an unsubstituted or substituted heterocyclic group,
a substituent of the substituted alkyl group is an alkyl group, an aryl group, a halogen atom, or a carbonyl group, a substituent of the substituted aryl group and a substituent of the substituted heterocyclic group are a halogen atom, a nitro group, a cyano group, an alkyl group, an alkyl halide group, an alkoxy group, or a carbonyl group, 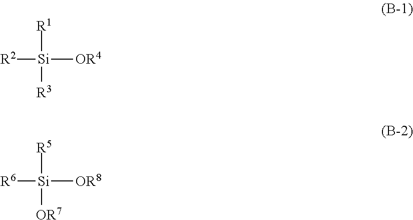
wherein, in the formulae (B-1) and (B-2), R¹, R², R³, R⁵, and R⁶ each independently represent an alkyl group having 1 to 10 carbon atoms, and R⁴, R⁷, and R⁸ each independently represent a methyl group, an ethyl group, or a phenyl group.

8. The method for producing an electrophotographic photosensitive member according to claim 7, wherein the metal oxide particle satisfies the following formula (1):
14≦S≦25(m²/g) (1)
wherein S represents a specific surface area (m²/g) of the metal oxide particle.

9. The method for producing an electrophotographic photosensitive member according to claim 7, wherein the metal oxide particle satisfies the following formulae (2) and (3):
0.02≦(A+B)≦0.40 (2)
0.01≦B/A≦1.0 (3)
wherein A represents a ratio of a mass of a compound represented by any one of the formulae (A-1) to (A-10) to a specific surface area S of the metal oxide particle, and
B represents a ratio of a mass of a compound represented by any one of the formulae (B-1) and (B-2) to a specific surface area S of the metal oxide particle.

10. The method for producing an electrophotographic photosensitive member according to claim 7, wherein the metal oxide particle is a metal oxide particle whose surface has been treated with a compound represented by any one of the formulae (A-1) to (A-10) and a compound represented by any one of the formulae (B-1) and (B-2).

11. The method for producing an electrophotographic photosensitive member according to claim 7, wherein the metal oxide particle is a particle comprising at least one selected from the group consisting of zinc oxide and titanium oxide.

12. The method for producing an electrophotographic photosensitive member according to claim 7, wherein R¹, R², R³, R⁵, and R⁶ in the formula (2) each independently represent an alkyl group having 1 to 5 carbon atoms.

13. A process cartridge that can be attached to and detached from a main body of an electrophotographic apparatus, the process cartridge comprising:
the electrophotographic photosensitive member according to claim 1; and
at least one device selected from the group consisting of a charging device, a developing device, a transfer device, and a cleaning device,
wherein the electrophotographic photosensitive member and the at least one device are integrally supported.

14. An electrophotographic apparatus comprising: the electrophotographic photosensitive member according to claim 1; a charging device; a developing device; and a transfer device.
